(19) United States
(12) Patent Application Publication
(10) Pub. No.: US 2004/0263974 A1
(43) Pub. Date: Dec. 30, 2004

(54) Flat polarization conversion system with patterned retarder

(75) Inventors: Jay McDonough, Santa Rosa, CA (US); Markus Duelli, Santa Rosa, CA (US); Anthony D. McGettigan, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Optical Coating Laboratory Inc., a JDS Unipahse Company and a corporation of the State of Delware, Santa Rosa, CA (US)

(21) Appl. No.: 10/609,307

(22) Filed: Jun. 26, 2003

(51) Int. Cl. G02B 5/30; G02B 27/28

(52) U.S. Cl. 359/487; 430/321; 430/20

(57) ABSTRACT

A polarization conversion system uses patterned half-wave retarder material and a polarizing beam splitter. The retarder material is applied to a surface of the polarizing beam splitter or other substrate before patterning. Patterning is accomplished by exposing the retarder material to oriented light, and may be done using an optical mask, or may be done through the polarization beam splitter. Selected areas of the patterned retarder layer produce no net rotation of light from the polarizing beam splitter, while other areas rotate light ninety degrees, thus providing polarization conversion.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates generally to liquid crystal display (“LCD”) systems, such as may be used in color televisions, business projectors, and computer displays, and more particularly to a light polarization conversion system.

### BACKGROUND

Most LCD projectors and projection systems use linearly polarized light at a light valve. The light valve is generally an array of reflective or transmissive pixels that turn on and off in a synchronized fashion to form an image from light that is illuminating the light valve. The image from the light valve is then typically focused onto a display screen.

It is desirable that the light illuminating the light valve has reasonably uniform intensity across the light valve so that the resultant image is uniformly illuminated on the screen. One way to achieve this homogenization is with a light pipe. Light pipes generally have an aperture at one end that admits light from a lamp or other light source. The light travels down the light pipe, reflecting off the walls of the light pipe, and exits the end of the light pipe. A light pipe can convert the circular cross section of the lamp output beam to the rectangular format and size of the light valve. The existing light can directly illuminate a light valve, or a lens system can be used to direct the homogenized light to the light valve.

Unfortunately, light from the lamp is not linearly polarized. If polarized light is required at the light valve, some method of polarization is needed. One way to achieve polarized light at the light valve is to remove light having the wrong polarization, thus providing light with the desired polarization to the light valve. For example, the undesired light could be absorbed, reflected away, or transmitted to a termination. This simple approach typically reduces the amount of light delivered from the lamp to the light valve by more than 50%.

Polarization conversion systems (“PCSs”) can recover most of the light that might otherwise be lost. A PCS generally converts the otherwise wasted light into light of the desired polarization. One approach to converting light to the desired polarization is to use a half-wave retarder plate. A polarizing beam splitter can be used to route the light with the desired polarization toward the light valve, and route the remaining light to a half-wave retarder plate. The half-wave retarder plate rotates the polarization state of the incident light to the desired polarization state, and this rotated light can then be routed toward the light valve. The beam splitting and rotation can occur before or after a light pipe.

Another technique separates the incident light beam into stripes of s- and p-polarized light (defined according to a reference plane, as is known in the art), and then uses stripes of half-wave retarder foil in the path of the set of stripes to be converted (i.e. rotated) to the complimentary polarization state. The stripes of retarder foil must be carefully cut and placed or etched to achieve optimum efficiency. These techniques require a number of steps, some of which can be labor intensive and require a high degree of skill, and can result in high yield loss or re-work.

### SUMMARY OF THE INVENTION

A layer of half-wave retarder material is patterned according to the images obtained from a polarizing beam splitter. In one embodiment, a PCS includes a polarizing beam splitter configured to couple light having a first polarization state to a first image and to couple light having a second polarization state to a second image. The patterned optical retarder includes a photochemically oriented base layer and a layer of photo-crosslinked liquid crystal birefringent monomers. In a particular embodiment, a first portion of the patterned optical retarder rotates the polarization state of the light zero degrees and a second portion of the patterned optical retarder rotates the polarization state of the light ninety degrees. The first portion corresponds to a first image area from the polarizing beam splitter and the second portion corresponds to a second image area from the polarizing beam splitter. Thus, the light of the second image is converted to the polarization state of the light of the first image, or vice versa, providing polarization conversion.

One method of fabricating a patterned retarder plate includes applying a layer of a base material to a polarizing beam splitter (“PBS”). A first portion of the layer of base material is oriented to a first polarization direction essentially parallel to a polarization of a first image of the PBS. A second portion of the layer of base material is oriented to a second polarization direction that is rotated forty-five degrees from the first polarization direction. A layer of liquid-crystal monomer is applied to the layer of base material, the layer of liquid-crystal monomer having a thickness selected to achieve a half-wave retardation for visible light that is polarized at forty-five degrees with respect to the retarder axis. The layer of liquid-crystal monomer is developed to align with the first polarization direction of the first portion of the layer of base material and to align with the second polarization direction of the second portion of the layer of base material.

In a specific embodiment, polarized light parallel to polarizing layers in the PBS is shone through the PBS to align and fix the retarder material in the first image area, and then the layer of retarder material, or at least the non-developed portions of the retarder material, is exposed to polarized light rotated forty-five degrees from the polarizing layers. This self-aligns the retarder plate pattern to the PBS.

### BRIEF DESCRIPTION OF THE DRAWINGS

FIG. 1A is a simplified cross section of a flat PCS according to an embodiment of the present invention.

FIG. 1B is a simplified cross section of a portion of the PBS and patterned retarder layer shown in FIG. 1A.

FIG. 1C is a simplified plan view of a patterned retarder layer according to an embodiment of the present invention.

FIG. 1D is a simplified plan view of a display system with a PCS and light pipe according to another embodiment of the present invention.

FIG. 2A is a simplified flow chart of a method of fabricating a flat polarization conversion recovery device according to an embodiment of the present invention.

FIG. 2B is a simplified flow chart of a method of patterning a half-wave retarder layer according to another embodiment of the present invention.

### DETAILED DESCRIPTION OF THE INVENTION

I. Introduction

A flat PCS can be used with lenslet arrays, a light rod, light tunnel, or other light integrator for use in a projection display system or other application. A polarizing splitter separates light from a lamp into two polarization states. A patterned retarder layer rotates light having the first polarization state to light of the second polarization state, so that essentially all the light from the flat PCS has the same polarization state, thus increasing the efficiency of light delivered from the lamp to the display screen. In one embodiment, a first array of lenslets gathers light from the lamp and focuses it on a second array of lenslets. The second array of lenslets then focuses the light on a corresponding series of polarizers, which provides a flat, compact PCS. The polarizers transmit light of a first polarization state to areas of the patterned retarder plate with essentially no rotational shift, and reflects light of the second polarization state to areas of the retarder plate that provide a 90° rotation of the polarization state. Thus, essentially all the light exiting the patterned retarder plate has a selected polarization state to illuminate the subsequent light valve. In other embodiments, the PCS is used with a light rod or light tunnel.

II. Exemplary PCSs

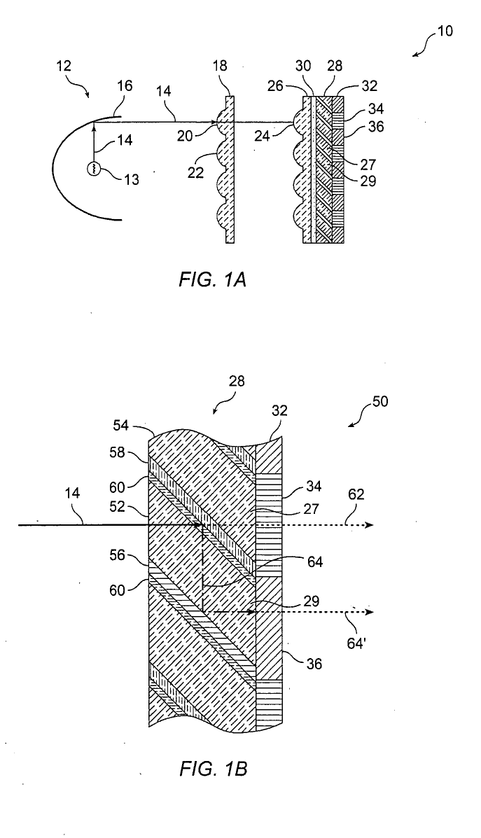

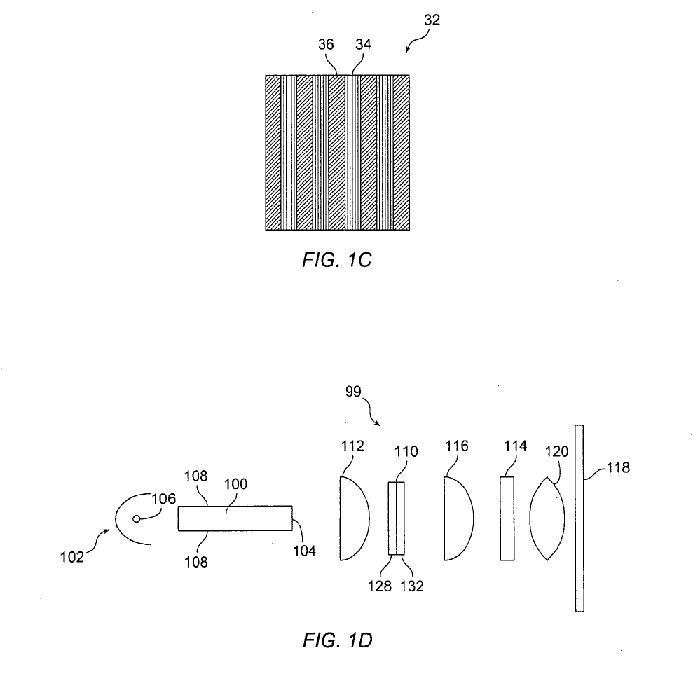

FIG. 1A is a simplified cross section of a flat PCS 10 according to an embodiment of the present invention. An arc or filament 13 of the lamp 12 generates light, represented by an arrow 14, that is reflected off a reflector 16 toward a first lenslet array 18. The reflector 16 is typically an elliptical or parabolic reflector that forms a light beam. The lenslet array 18 includes a series of cylindrical lenslets 20, 22, and is typically cast or molded from optical polymer material. Other materials and fabrication methods may be used, and it is not necessary that the lenslets be cylindrical, or of the same size or shape. In a particular embodiment, the lenslets are square or rectangular.

The lenslets in the first lenslet array image light from the light beam to a corresponding lenslet 24 in the second lenslet array 26. The first and second lenslet arrays operate in conjunction with the reflector 16 as an optical integrator, and are illustrated as having similar configurations, but each array may have a different type or shape of lens. Similarly, it is not necessary that either lenslet array be flat.

A polarizing beam splitter (PBS) panel 28 receives light from the lamp through the lenslet arrays, and separates the light into polarization states. The PBS panel includes a number of cells with half-cells 27, 29 that separate the essentially homogeneous light into stripes (or other configurations) of s- and p-polarization light. The second lenslet array 26 can be attached to the PBS panel 28 with an optical adhesive 30, or held in place with a fastener. The operation of the PBS cells and panel is discussed in further detail in reference to FIG. 1B, below.

A sheet of patterned retarder material 32, commonly called a retarder plate, or in this case a patterned retarder plate, adjoins the PBS panel 28. The patterned retarder plate 32 includes a first region 34 that imparts a first polarization rotation shift to light passing through the retarder plate 32 and a second region 36 that imparts a second polarization rotation shift.

FIG. 1B is a simplified cross section of a portion of a PCS plate 50 according to an embodiment of the present invention. The PBS panel 28 may be made a number of different ways. For example, glass slides 52, 54 are coated on one side with either a reflector layer(s) 56 or a polarizing layer 58. The polarizing layer 58 is a multi-layer thin film coating that transmits light having a first polarization state and reflects light having a second polarization state, but other types of polarizing layers could be used.

The slides are stacked in an alternating fashion and may be joined together with layers of adhesive 60, such as an optical epoxy, or otherwise bonded or held together. The stack of coated slides is then cut into strips at a forty-five-degree angle. The thickness of the slides and width of the bias-cut strips are chosen according to the pitch of the lenslets in the corresponding array so that light 14 from the lenslet is split by the polarizing layer 58.

Light of one polarization type (e.g. p-polarized light), represented by the dashed arrow 62, is transmitted through the polarizing layer 58 and first half-cell 27 toward the patterned retarder plate 32, and light of the other polarization type (e.g. s-polarized light), represented by the dashed arrow 64, is reflected at an essentially right angle to the reflector layer 56 in the adjoining half-cell 29 of the PBS panel 28. The reflector layer 56 then reflects this light toward the patterned retarder plate 32. The polarization states are arbitrarily chosen for convenience of illustration, and those of skill in the art understand that s- and p-polarization is in reference to a selected plane.

The light 62 transmitted through the polarizing layer 58 is transmitted through a first region 34 of the patterned retarder plate 32 that imparts essentially no polarization rotation shift to the light. The light 64 reflected off the polarizing layer 58 and then off the reflector layer 56 is transmitted through a second region 36 of the patterned retarder plate 32 that imparts essentially ninety degrees of polarization rotation shift to form rotated light 64′. The rotated light 64′ now has essentially the same polarization state as the light 62 transmitted through the polarizing layer 58 and through the first region 34 of the patterned retarder plate 32.

It is not necessary that each cell of a PBS be the same thickness or that the light from a lenslet fall at essentially the center of the polarizing layer. The light rays or beams represented by arrows typically illuminate a region, and not merely a point. The use of such arrows is for simplicity of illustration.

FIG. 1C is a simplified plan view of the patterned retarder plate 32 patterned in stripes according to an embodiment of the present invention. The first region 34 of the patterned retarder plate 32 a is stripe of retarder material developed to provide a first polarization rotation (in one instance, essentially zero net rotation) and a second region 36 of the patterned retarder plate 32 is a stripe of retarder material developed to provide a second polarization rotation (in this instance, essentially ninety degrees net rotation). The pattern of the retarder plate corresponds to a lenslet array having rectangular-shaped lenses on essentially half the pitch of the stripes in the retarder material. Other lenslet arrays, such as an array of cylindrical lenslets, could be used, and a variety of alternative patterns of the retarder plate material are possible.

In a particular embodiment, the patterned retarder plate 32 is made by applying (e.g. by a spin-on process) a coating of photosensitive material to the PBS panel 28, and then developing the material to achieve different degrees of polarization shift in different regions (i.e. striped regions 34, 36) that correspond to different polarization areas of the PBS panel. Alternatively, photosensitive material is applied to a separate substrate, such as a glass slide, which is then optically coupled to the PBS panel 28.

The retarder is patterned in such a way that for one set of images (from the PBS panel) the fast or slow axis of the retarder material is aligned with respect to the linear polarization of the incoming light. Therefore, the polarization state remains essentially unchanged when light passes through that portion of retarder material. For the other set of images, the axis of the retarder material is aligned at an angle to the polarization of the light. Thus, the light is split into a fast and slow component when traveling through the retarder material and the polarization state of the light changes as it passes through the retarder material. By properly selecting the angle and thickness of the retarder material, a difference in polarization rotation angle of ninety degrees can be obtained. In one embodiment, the rotation through a first area of the patterned retarder plate is about zero degrees, and the rotation through a second area of the patterned retarder plate is about ninety degrees. Other combinations of rotation may be desirable, and it is not necessary that the polarized light output be in the p-polarization or s-polarization state.

In one embodiment, the patterned retarder plate consists of a photochemically oriented base layer, commonly called a linear photo-polymerization (“LPP”) layer, and photo-crosslinkable liquid-crystal (“LC”) monomer. One example of a suitable LPP is polyvinyl 4-methoxy-cinnamate (“PVMC”), which is used as a photoresist. PVMC photoresist is typically exposed with isotropic light. However, PVMC that is photopolymerized with linearly polarized light orients the PVMC layer according to the direction of polarization of the light.

A base layer of PVMC is applied to a PBS panel or glass slide using spin-coating or other techniques. A mask is used to expose a first set of images in an exposure pattern that corresponds to the set of half-cells with light that is linearly polarized in the direction of light that will be provided by a first set of half-cells of the PBS. The axis of the exposed base layer material aligns with the polarization direction of the illuminating light and cross-links. The base layer material in the exposed areas is fixed (developed) and is not significantly altered during subsequent exposure to light. Next, the mask is removed and the polarization of the illuminating light is rotated by forty-five degrees to expose the previously masked areas, which have not yet cross-linked.

Thus, the axis of these previously masked areas aligns at forty-five degrees with respect to the polarization of the first set of images and cross-links. In this example, the polarized light used to develop the base layer material is shone on the top of the base layer material when it is applied to a PBS, but may be shone from either side if the base layer material is applied to a glass slide. Alternatively, a patterned retarder plate could be made by developing the second set of images (i.e. by exposing the top of the layer of retarder material to light polarized at forty-five degrees from the polarization direction of light from the adjoining half-cells of the PBS) to provide the desired polarization shift, and washing out the base layer material and/or birefringent material in the areas of the first set of images to transmit light through the washed-out areas with no polarization shift. In an alternative embodiment, the base layer is polymerized using unpolarized light.

Then, a layer of birefringent polymer, such as a light-polymerizing liquid-crystal polymer (“LCP”), is applied over the patterned and developed base layer at a thickness selected to achieve a half-wave retardation in transmission. As used herein, the term “birefringent polymer” or “LCP” refers to both the starting material and the material after it has been cross-linked. The LCP is typically applied as a liquid monomer that is subsequently polymerized using light, and the term “polymer” is used for both the monomer precursor and cross-linked polymer materials for convenience of discussion, as is common in the art.

The thickness of the layer of LCP is selected to achieve a half-wave retardation for light at the selected wavelength (e.g. visible light) that is polarized at forty-five degrees with respect to the fast or slow axis of the retarder. The axis of the LCP material aligns itself to the oriented base layer through molecular interaction. Subsequent illumination of the LCP with isotropic light cross-links the material and fixes the orientation of the axis of what is now a birefringent, patterned layer of light-polymerized material. The retarder is patterned in such a way that the polarization state of one set of images (from the lenslet array or other light integrator) is not significantly changed when passing through the patterned retarder, while the polarization state of the other set of images is rotated ninety degrees.

Conventional retarder devices for PCSs are assembled from a number of strips of retarder material that are cut from a sheet, and then attached to a PBS. Each strip is aligned to a corresponding lenslet image, which can be time-consuming and labor intensive. A potential consequence of this approach is that the number of strips, and hence number of lenslets, is kept to a minimum to reduce the part count, assembly time, and yield loss of the retarder plate. With patterned retarder plates according to embodiments of the present invention, a great number of patterned areas can be produced on the retarder plate with no significant increase in labor, component count, or yield loss. This in turn allows greater flexibility in choosing the corresponding lens system. For example, a greater number of narrower, thinner square lenses could be used. Similarly, relatively small patterned retarders can be produced, which could be very difficult to assemble from cut retarder plate material.

Patterned retarder plates according to the present invention resist delamination better than conventional retarder plates made with cut retarder plate material, and are less susceptible to changes in polarization shift arising from heat-induced or mechanical stress. In particular, sheet retarder plate material is typically made by stretching, buffing, or otherwise mechanically stressing the retarder plate material in a selected direction to align molecules in the sheet. Thus, stress subsequently applied to the sheet retarder plate material alters its polarization characteristics. Such stress-induced changes in polarization shift are less likely to occur in patterned retarder plates that use light to orient the retarder material.

In another embodiment, the light for fixing the base material of a retarder plate is linearly polarized parallel to the polarization of one set of images (i.e. one set of half-cells) of the PBS panel, and is shone though the PBS panel. The PBS panel directs areas of polarized light onto a first set of images on the retarder plate. In other words, the exposure light is polarized parallel to the polarization layer (see FIG. 1B, ref. num, 58) in one set of half-cells of the PBS panel. Essentially all of the exposure light is transmitted through these half-cells of the PBS, and essentially no light is reflected to the other set of half-cells. Alternately, the polarization of the light is such that essentially all of it is reflected to the other half-cells, and none is transmitted through the first set of half-cells. Therefore, only areas of the base material on the retarder plate that are optically coupled to the polarized light transmitted through the PBS are exposed and developed.

The exposed areas of the base material then polymerize and are self-aligned with the polarization state of the light that will be coupled from the PBS panel when the PCS is operated. For the second set of images, the polarization of the light is rotated forty-five degrees and the material is illuminated directly from the top of the layer of retarder material, not through the PBS. This polymerizes these areas of the base material at a rotation of forty-five degrees from the previously exposed and developed base material. A half-wave layer of LCP is then applied over the base layer and developed. Thus, no mask is needed for patterning the retarder, and the pattern is self-aligned to the image array from the lenslet-PBS panel assembly.

Other types of materials, such as photoreactive moieties including linear or cyclic ethane groups attached to polymeric chains with their backbone being polyvinyl, polysiloxan, or polyimied, or ferro-electric liquid crystal materials can be developed to obtain polarization shifts. In some instances, the light used to polymerize the retarder material is of a different wavelength (e.g. ultraviolet) than the light used in the projection system. Similarly, one type of energy, such as an electric or magnetic field, might be applied to orient molecules in the layer, while another type of energy, such as light or heat, is applied to fix the orientation of the molecules. Thus, suitable retarder material does not have to exhibit light-sensitive polymerization. Similarly, a retarder plate could be patterned before optically coupling the patterned retarder plate to the PBS panel, and aligning the patterned retarder plate to the PBS panel.

FIG. 1D is a simplified plan view of a display system 99 with a PCS 110 and light pipe 100 according to another embodiment of the present invention. The light pipe 100 is a light rod or light tunnel, and such devices are typically used as light integrators to homogenize light from a lamp 102. An output face 104 of the light pipe 100 provides an essentially uniform plane of light resulting from multiple reflections of the image of an arc or filament 106 of the lamp off walls 108 of the light pipe 100. However, the images of the arc 106 (i.e. the multiple reflections of the arc off the walls 108 of the light pipe 100) will separate as one moves away from the output face 104, typically forming a grid of arc images. A lens system 112 is used to collimate and focus the arc images on the PCS 110.

The PCS 10 includes a PBS 128 and a patterned retarder plate 132 and transmits light having a selected polarization state to a light valve 114 through a second lens system 116. The light valve 114 acts as a spatial light modulator and provides modulated light to a display screen 118 through a third lens system 120. The patterned retarder plate 132 is patterned according to the half-cell pattern of the PBS 128, and can be self-aligned to the PBS 128 or patterned using a photomask, as discussed above in relation to FIG. 1B. The pitch of the PBS 128 is selected according to a grid of arc images at the plane of the PBS 128 so that light from the arc images is split by the polarizing layers in the PBS cells. The grid of arc images can be determined in a variety of ways, such as measuring the light intensity at the plane of the PBS 128 with a charge-coupled diode array or scanning photodetector. Hence light having multiple polarization states is provided to the PCS 110 from the light pipe 100, and the PCS 110 provides light having essentially one polarization state to the light valve 114.

Although the display system is shown in a linear configuration, various mirrors may be used in a folded configuration. Similarly, the lens systems and light valve are highly simplified, and a display system may have more than one light valve and color-splitting optics to separately modulate various colors of the polarized light.

III. Exemplary Methods of Manufacturing a Patterned Retarder Plate

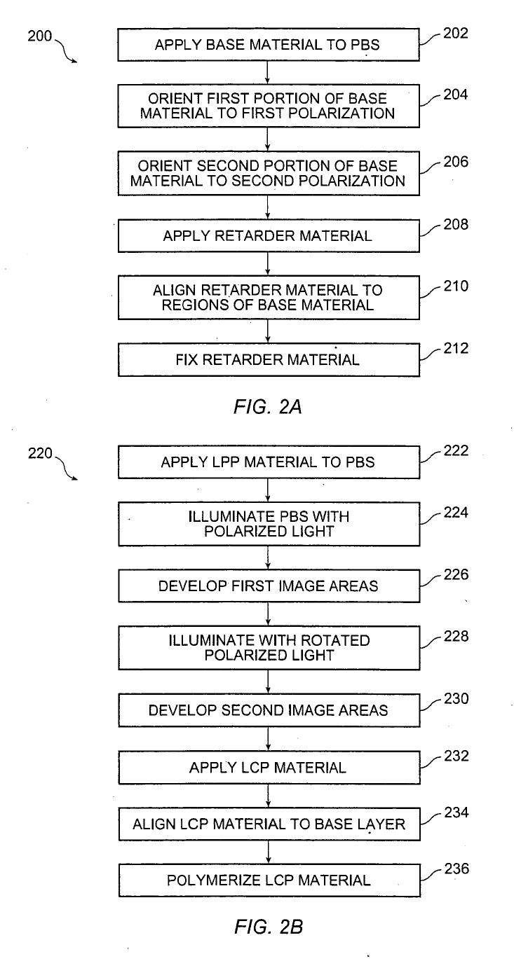

FIG. 2A is a simplified flow chart of a method 200 of fabricating a flat polarization conversion device according to an embodiment of the present invention. A layer of base material is applied to a surface of a PBS (step 202). The base material is generally an LPP material that is applied in a fluid state in a spin-on, spray, dip, roller, or similar process.

A first portion of the layer of base material is oriented to a first polarization direction essentially parallel to a polarization state of a first polarized image (step 204). In one embodiment, the base layer material is photo-chemically oriented by exposure to light having a first polarization through a photo-mask. A second portion of the layer of base material is orientated to a second polarization direction (step 206). In a particular embodiment, the photo-mask is removed after the first portion is oriented and the layer of base material is illuminated with light having a second polarization direction that has essentially forty-five degrees of rotation from the first polarization direction. The previously developed first portion does not significantly change state, even though it is illuminated again. This allows a single-mask process. A double-mask process might be appropriate in other embodiments, such as when the development (e.g. polymerization) occurs separately from the alignment (e.g. exposure).

A layer of birefringent polymer material, such as an LCP, is applied to the base layer at a thickness selected to achieve a half-wave retardation for visible light that is polarized at forty-five degrees with respect to the retarder axis after development of the layer (step 208) The birefrigent polymer material is aligned or aligns itself to the base layer (step 210) and is polymerized (step 212). In a particular embodiment, the LCP material is polymerized by exposure to isotropic light to fix the orientation of the axes of the birefringent polymer. Thus, the retarder material is patterned in such a way that it does not affect the polarization of one set of images and acts as a half-wave plate (ninety degree polarization rotation) for the other set of images.

FIG. 2B is a simplified flow chart of a method 220 of patterning a half-wave retarder layer according to another embodiment of the present invention. A layer of LPP base material is applied to a first surface of a PBS (step 222). Light polarized essentially parallel to a polarization orientation of a first half-cell of the PBS is provided to a second surface of the PBS panel and shone through the PBS to illuminate a first portion of the base material (step 224). The first portion of the base material is developed (step 226), being self-aligned to the polarization orientation of the first half-cell of the PBS.

Light polarized essentially forty-five degrees from the polarization orientation of the first image of the PBS is provided to the layer of base material (i.e. the first surface of the PBS) (step 228), and the remaining portions of the layer of base material are developed (step 230). The first portions remain aligned to the polarization orientation of the PBS because they have been fixed in the development step(s). A layer of birefringent polymer material is applied to the base layer at a thickness selected to achieve a half-wave retardation for visible light that is polarized at forty-five degrees with respect to the retarder axis (step 232). The birefringent polymer material is aligned or aligns itself to the base layer (step 234) and is polymerized (step 236).

While the invention has been described above in terms of various specific embodiments, the invention may be embodied in other specific forms without departing from the spirit of the invention. Thus, the embodiments described above illustrate the invention, but are not restrictive of the invention, which is indicated by the following claims. All modifications and equivalents that come within the meaning and range of the claims are included within their scope.

We claim:

1. A polarization conversion system comprising:
a polarizing beam splitter configured to couple light having a first polarization state to a first region and to couple light having a second polarization state to a second region;
a patterned optical retarder having a first portion of retarder material optically coupled to the first region and a second portion of retarder material optically coupled to the second region, the first portion of the patterned optical retarder providing a first polarization rotation to the light of the first polarization state and the second portion of the patterned optical retarder providing a second polarization rotation to the light of the second polarization state.

2. The polarization conversion system of claim 1 wherein the first polarization rotation is zero degrees and the second rotation is 90 degrees.

3. The polarization conversion system of claim 1 wherein the first polarization rotation is 90 degrees and the second rotation is zero degrees.

4. The polarization conversion system of claim 1 wherein light having the second polarization state obtains the first polarization state when rotated by the second portion of the retarder material.

5. The polarization conversion system of claim 1 wherein the patterned optical retarder includes a photochemically oriented base layer and a layer of photo-crosslinked liquid crystal molecules.

6. The polarization conversion system of claim 1 wherein the polarizing beam splitter comprises a first half-cell that transmits light of the first polarization state to the first region and reflects light of the second polarization state to a second half-cell, the second half cell reflecting the light of the second polarization state to the second region.

7. The polarization conversion system of claim 1 wherein the patterned optical retarder is disposed on the polarizing beam splitter.

8. The polarization conversion system of claim 1 wherein the patterned optical retarder is self-aligned to the polarizing beam splitter.

9. The polarization conversion system of claim 1 wherein the patterned optical retarder is patterned according to a lenslet array.

10. The polarization conversion system of claim 1 wherein the patterned optical retarder is patterned according to an image grid from a light pipe.

11. A polarization conversion system comprising:
a polarizing beam splitter configured to couple light having a first polarization state to a first image and to couple light having a second polarization state to a second image;
a patterned optical retarder including a photochemically oriented base layer and a layer of photo-crosslinked birefringent liquid crystal polymer, the patterned optical retarder having a first portion providing a first net polarization of zero degrees optically coupled to the first image and a second portion providing a second net polarization rotation of ninety degrees optically coupled to the second image.

12. The polarization conversion system of claim 11 wherein the polarizing beam splitter is a polarizing beam splitter panel, and further comprising:
a lenslet array optically coupled to the polarizing beam splitter panel.

13. The polarization conversion system of claim 12 wherein the lenslet array is an array of square lenses.

14. The polarization conversion system of claim 11 further comprising:
a light pipe configured to receive light from a light source, the light pipe providing an image array of the light source to the polarizing beam splitter, wherein the patterned optical retarder is patterned according to the image array.

15. A method of fabricating a patterned retarder plate, the method comprising steps of:
applying a layer of a base material to a polarizing beam splitter (“PBS”);
orienting a first portion of the layer of base material to a first polarization direction, the first polarization direction being essentially parallel to a polarization of light from a first half-cell of the PBS;
orienting a second portion of the layer of base material to a second polarization direction, the second polarization direction being rotated forty-five degrees from the first polarization direction;
applying a layer of birefringent polymer material on the layer of base material, the layer of birefringent polymer material having a thickness selected to achieve, after polymerization, a half-wave retardation for visible light that is polarized at forty-five degrees from the first polarization direction; and
polymerizing the layer of birefringent polymer material to align with the first polarization direction of the first portion of the layer of base material and to align with the second polarization direction of the second portion of the layer of base material.

16. The method of claim 15 wherein the birefringent polymer material comprises liquid-crystal polymer material.

17. The method of claim 15 wherein the layer of birefringent polymer material is polymerized by exposure to isotropic light.

18. The method of claim 15 wherein the base material is photo-chemically orientable and the step of orienting the first portion of the layer of base material includes masking a second portion of the base material with a photomask and illuminating a first portion of the base material to first linearly polarized light parallel to the polarization of a first image of the PBS.

19. The method of claim 18 wherein the step of orienting the second portion of the layer of base material includes removing the photomask and illuminating the first portion of the base layer material and the second portion of the base layer material with second linearly polarized light having a polarization direction rotated forty-five degrees from the first linearly polarized light.

20. The method of claim 15 wherein the step of orienting the first portion of the layer of base material comprises illuminating the first portion of the layer of base material through the PBS with first linearly polarized light, and the step of orienting the second portion of the layer of base material comprises illuminating the layer of base material with second linearly polarized light having a second polarization orientation rotated forty-five degrees from the first polarization orientation.

21. The method of claim 20 wherein the step of orienting the second portion of the layer of base material comprises illuminating the layer of base material from a side opposite the PBS.

22. A patterned retarder plate manufactured according to the method of claim 15.

23. A method of fabricating a patterned retarder plate, the method comprising steps of:
applying a layer of a photo-definable retarder material to a surface of a polarizing beam splitter (“PBS”);
illuminating the PBS with first linearly polarized light having a first polarization orientation parallel to a polarization orientation of an image from the PBS to orient a first portion of the photo-definable retarder material to the first polarization orientation;
fixing the orientation of the first portion of the photo-definable retarder material;
illuminating the layer of photo-definable retarder material with second linearly polarized light having a second polarization orientation rotated forty-five degrees from the first polarization orientation to orient a second portion of the photo-definable retarder material to the second polarization orientation; and
fixing the orientation of the second portion of the photo-definable retarder material.

24. The method of claim 23 wherein the step of fixing the orientation of the first portion of the photo-definable retarder material is concurrent with the step of illuminating the PBS and the step of fixing the orientation of the second portion of the photo-definable retarder material is concurrent with the step of illuminating the layer of photo-definable material.

25. The method of claim 23 wherein the layer of photo-definable retarder material comprises a layer of birefringent polymer material disposed on a layer of photochemically orientable base material.
